(19) United States
(12) Patent Application Publication
(10) Pub. No.: US 2008/0168262 A1
(43) Pub. Date: Jul. 10, 2008

(54) Methods and Apparatus for Software Control of a Non-Functional Operation on Memory

(76) Inventors: Mark David Bellows, Rochester, MN (US); John David Irish, Rochester, MN (US); David Alan Norgaard, Rochester, MN (US); Tolga Ozguner, Rochester, MN (US); Dorothy Marie Thelen, Rochester, MN (US)

Correspondence Address: Matthew C. Zehrer, Agent;IBM Corporation, Dept. 917, 3605 Hwy. 52 North, Rochester, MN, 55901, US

(21) Appl. No.: 11/620,117

(22) Filed: Jan. 5, 2007

(51) Int. Cl. G06F 9/312

(52) U.S. Cl. 712/225; 712/E09.033

(57) ABSTRACT

In a first aspect, a first method of controlling a non-functional operation on a memory of a computer system using software is provided. The first method includes the steps of (1) employing a processor to write bits of data to at least one register external to the processor, wherein the bits of data serve as control bits for the memory; and (2) applying the bits of data to respective pins of the memory so as to cause the non-functional operation to be performed on the memory. Numerous other aspects are provided.

### FIELD OF THE INVENTION

The present invention relates generally to computer systems, and more particularly to methods and apparatus for software control of a non-functional operation on memory.

### BACKGROUND

A computer system may include a main processor coupled to a memory (e.g., a DRAM) via a memory controller. Conventional systems may include hardware, such as sequencer logic, adapted to perform non-functional operations on the memory, such as memory initialization and/or testing. However, the initialization and/or testing using such an approach is not flexible. For example, the sequencer logic may be hard-wired and adapted to perform a fixed sequence of operations during memory initialization and/or testing. Further, the sequencer logic may include a large amount of logic which consumes a large amount of space in the system. Accordingly, improved methods, apparatus and systems are desired for performing non-functional operations (e.g., initialization and/or a test) on memory of a computer system.

### SUMMARY OF THE INVENTION

In a first aspect of the invention, a first method of controlling a non-functional operation on a memory of a computer system using software is provided. The first method includes the steps of (1) employing a processor to write bits of data to at least one register external to the processor, wherein the bits of data serve as control bits for the memory; and (2) applying the bits of data to respective pins of the memory so as to cause the non-functional operation to be performed on the memory.

In a second aspect of the invention, a first apparatus for controlling a non-functional operation on a memory of a computer system using software is provided. The first apparatus includes (1) one or more processors; and (2) one or more registers external to the processors and coupled thereto and further adapted to couple to the memory. The apparatus is adapted to (a) employ one of the processors to write bits of data to at least one of the registers, wherein the bits of data serve as control bits for the memory; and (b) apply the bits of data to respective pins of the memory so as to cause the non-functional operation to be performed on the memory.

In a third aspect of the invention, a first system for controlling a non-functional operation on a memory of the system using software is provided. The first system includes (1) one or more processors; (2) one or more registers, external to the processors and coupled thereto; and (3) a memory coupled to the one or more registers. The system is adapted to (a) employ one of the processors to write bits of data to at least one of the registers, wherein the bits of data serve as control bits for the memory; and (b) apply the bits of data to respective pins of the memory so as to cause the non-functional operation to be performed on the memory. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a first exemplary system for controlling a non-functional operation on a memory of the system using software in accordance with an embodiment of the present invention.

FIG. 2 illustrates a method of controlling a non-functional operation on a memory of the system using software in accordance with an embodiment of the present invention.

FIG. 3 is a block diagram of a second exemplary system for controlling a non-functional operation on a memory of the system using software in accordance with an embodiment of the present invention.

### DETAILED DESCRIPTION

The present invention provides improved methods, apparatus and systems for performing a non-functional operation on memory of a computer system. More specifically, the present invention employs software to control performance of a non-functional operation on the memory. By employing software to initiate a non-functional operation on the memory, the present invention provides flexibility. For example, the software may allow steps in a memory initialization, testing or similar sequence to be customized during each memory initialization or test. Further, by employing software to control a non-functional operation on the memory, the present apparatus and systems may include a reduced amount of hardware (compared to conventional systems). For example, the present invention may eliminate the need for a sequencer. By reducing hardware required to perform such non-functional memory operations, the present invention reduces space required by the computer system.

The computer system may include a main processor coupled to a memory (e.g., a DRAM) via a memory controller. The main processor may be included on the same printed circuit board (PCB) as the memory controller. Further, in accordance with a first embodiment of the present invention, the memory controller may include one or more registers adapted to store bits of data which serve as at least a portion of command signals for the memory. The command signals may cause initialization and/or testing of the memory. The main processor may read data from and/or write data to the one or more registers via a first interface. Alternatively or additionally, a second processor, external to the PCB, may read data from and/or write data to the one or more registers via a second interface. Data written to the one or more registers by a processor may determine when and how memory initialization or a memory test is performed.

In accordance with a second embodiment of the present invention, the memory controller may include a first register adapted to store data indicating whether the system operates in an impedance adjustment mode during which impedance on pins of the memory are matched with that on a bus line coupled thereto. Further, the memory controller may also include a second register adapted to store data, which serves as a portion of a command which causes the memory to undergo the above-described impedance adjustments. Data may be read from and/or written to the first and second registers by the main processor or an external processor. Remaining portions of such a command may be provided to the memory by the main processor. Thus, data written to the second register by a processor may determine (in part) when and how impedance adjustments/calibrations are performed on the memory.

In this manner, the present invention provides methods, apparatus and systems that employ software to control performance of non-functional operations on the memory.

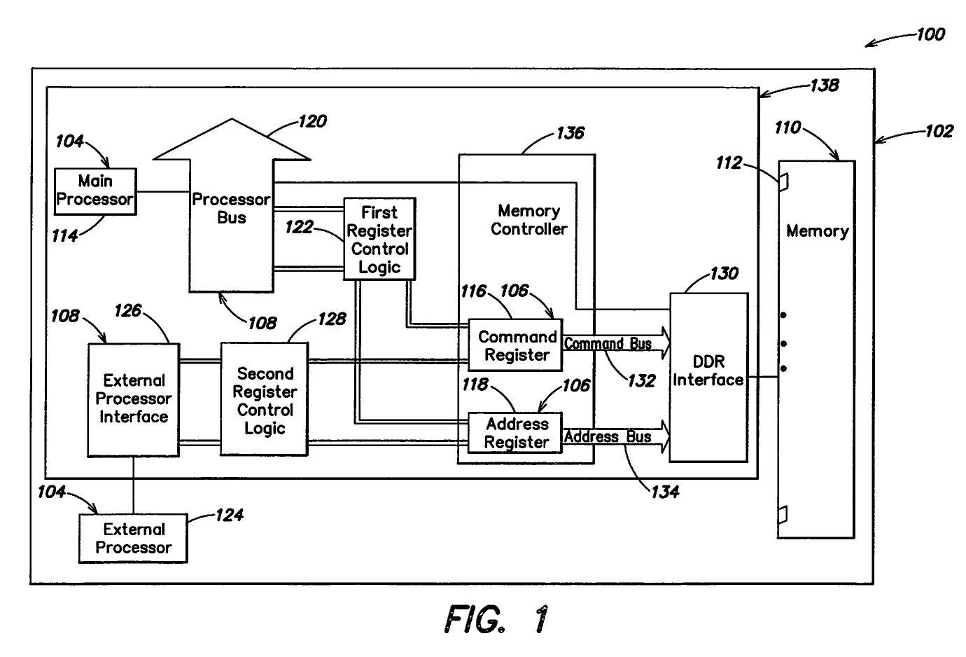

FIG. 1 is a block diagram of a first exemplary system 100 for controlling a non-functional operation on a memory of the system using software in accordance with an embodiment of the present invention. With reference to FIG. 1, the system 100 may be a computer 102 or similar device. The system 100 may include one or more processors 104 coupled to one or more registers 106 via respective interfaces 108. The one or more registers 106 may be coupled to a memory 110 (e.g., DRAM) of the system 100. The memory 110 may perform functional operations, such as allowing data to be read therefrom and/or written thereto. Further, the memory 110 may perform non-functional operations, such as a memory test or a memory initialization. Details of a memory test and memory initialization are described below.

Each processor 104 may be adapted to execute code which causes data to be read from and/or written to the registers 106. For example, each processor 104 may write data to one or more of the registers 106. The registers 106 will store the data written thereto by the processors 104. Such data may serve as control bits that may cause the memory 110 to perform a non-functional operation. The data may include a first set of bits that cause the memory to perform a first sequence of steps during a non-functional operation such as memory initialization. For example, the first sequence may include a first step in which all banks of the memory are pre-charged and a second step in which the memory enters a power down mode. Thereafter, the processor may write a second set of bits that cause the memory to perform a second sequence of steps during memory initialization. The second sequence of steps may include the same steps as the first sequence but in a different order. For example, the second sequence may include a first step in which the memory enters the power down mode and a second step in which all banks of the memory are pre-charged. Alternatively, the second sequence may include a larger or smaller number of steps and/or different steps than the first sequence. Thus, the system 100 may customize a non-functional operation by varying such control bits.

In the present system, a processor 104 may directly write memory control signals to the registers 106 which may be applied to respective pins 112 of the memory 110 and cause the memory 110 to perform a non-functional operation. Consequently, the present system 100 may not require additional hardware, such as sequencer logic, to perform a memory test and/or initialization. Therefore, a space required by the present system 100 may be reduced (compared to that required by conventional systems).

More specifically, the system 100 may include a first processor 114, such as a main processor, coupled to a first and second registers 116, 118 via a processor bus 120. The first register 116 may be a control register which is adapted to store data indicating a command to be performed on the memory 110 as part of the non-functional operation. The second register 118 may be an address register which is adapted to store data indicating an address associated with the non-functional command to be performed on the memory 110. First register control logic 122 may be coupled to the processor bus 120 and adapted to decode commands on the processor bus 120 and read data from and/or write data to the one or more registers 116, 118.

The system 100 may include a second processor 124 which may be external to the main processor 114, coupled to the first and second registers 116, 118 via an external processor interface 126. In some embodiments, the external processor interface 126 may be a serial peripheral interface (SPI), an Inter-IC (I²C) interface or another suitable interface adapted to enable the external processor 124 to access the registers 116, 118. Second register control logic 128 may be coupled to the external processor interface 126 and adapted to decode commands on the interface 126 and read data from and/or write data to the one or more registers 116, 118. Although first register control logic 122 is shown separate from the second register control logic 128, in some embodiments, the first and second register control logic 122, 128 may be integrated and coupled to both the processor bus 120 and external processor interface 126.

The first and second registers 116, 118 may be external to the one or more processor 104 (e.g., may be MMIO registers). Further, the first and second registers 116, 118 may be coupled to the memory 110 via a memory interface 130, such as a dual data rate (DDR) interface or other suitable interface. For example, the first register 116 may be coupled to the memory interface 130 via a command bus 132. The command bus 132 may be adapted transmit data stored by the first register 116 to the memory interface 130. As described above, the data stored by the first register 116 may indicate a command to be performed on the memory 110 as part of the non-functional operation, and data stored by the second register 118 may indicate an address associated with the command to be performed on the memory 110. Similarly, the second register 118 may be coupled to the memory interface 130 via an address bus 134. The address bus 134 may be adapted to transmit data stored by the second register 118 to the memory interface 130.

In some embodiments, the first and second registers 116, 118 may be included in a memory controller 136 of the system 100 (although the first and/or second registers 116, 118 may be positioned elsewhere). The memory controller 136 may be coupled to the memory interface 130 and adapted to control the flow of data to and from the memory 110. The memory interface 130 may serve as an interface between the memory controller 136 and the memory 110. For example, the memory interface 130 may receive the data stored by the first and second registers 116, 118 and apply such data to corresponding pins 112 of the memory 110 so as to cause the memory 110 to perform the non-functional operation. Additionally or alternatively, the memory interface 130 may receive a functional operation, such as a memory read or write from the main processor 114 via the memory controller 136.

In some embodiments, the main processor 114 and memory controller 136 may be included on a single printed circuit board (PCB) 138, and the processor 124 may be external to such PCB 138. However, in some embodiments, the main processor 114 and memory controller 136 may be on separate PCBs 138.

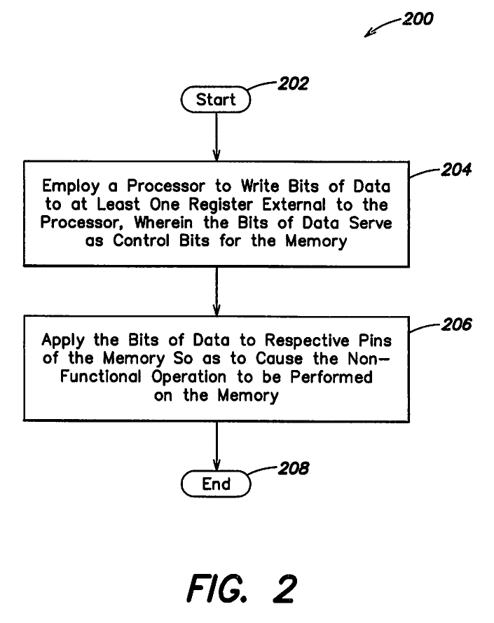

Operation of the system is now described with reference to FIG. 2 which illustrates a method 200 of controlling a non-functional operation on a memory 110 of the system 100 using software in accordance with an embodiment of the present invention. With reference to FIG. 2, in step 202, the method 200 begins. In step 204, a processor 104 may be employed to write bits of data to at least one register 116, 118 external to the processor 104. The bits of data may serve as one or more portions of control bits for the memory 110 that indicate the non-functional operation that is to be performed on the memory 110.

The processor 104 may write bits of data to the first and second registers 116, 118 that may represent one of the steps associated with memory initialization when such bits are applied to corresponding pins 112 of the memory 110. For example, the main processor 114 may issue a command and an address associated therewith on the processor bus 120. The first register control logic 122 may decode such data on the processor bus 120, and read data from or write data to the first and/or second register 116, 118 based on the decoding. In this manner, the first register control logic 122 may translate a read and/or write command to a register access by decoding an address range associated with the command. Initialization may be a sequence of commands performed by the memory 110 before the memory 110 may enter into a normal, functional operational state.

Alternatively or additionally, an external processor 124 may write bits of data to the first and/or second registers 116, 118 that may represent one of the steps associated with a memory test when such bits are applied to corresponding pins 112 of the memory 110. For example, the external processor 124 may issue a command and an address associated therewith on the external processor interface 126. The second register control logic 118 may decode such data on the external processor interface 126, and read data from or write data to the first and/or second register 116, 118 based on the decoding. In this manner, the second register control logic 128 may translate a read and/or write command to a register access by decoding an address range associated with the command. The memory test may be a sequence of commands performed to test and/or debug a newly-designed memory (e.g., during lab bringup) and/or memory interface 130. Although memory initialization and a memory test are described above, any other memory command supported by the memory interface 130 may be generated by employing a processor 104 to perform the above-described register write operation. Consequently, the present invention may force a command to memory 110 through a register write operation.

In some embodiments, if an external processor 124 is attempting to access a register 116, 118 via the external memory interface 126 at the same time as the main processor 104 is attempting to access the register 116, 118 via the processor bus 120, the register control logic 122, 128 may grant priority to the main processor 104. Consequently, the register control logic 122, 128 may delay register access for the external processor 124 by one or more clock cycles.

By adjusting the bits of data written to one or more of the registers 116, 118, the processor 104 may control the type of non-functional operation performed on the memory 110. Therefore, employing the processor 104 to directly write data (e.g., via the first register control logic 122 and processor bus 120 or the second register control logic 128 and external processor interface 126) to one or more of the registers 114, 116 provides a flexible method of performing a non-functional operation on the memory 110.

All commands to the memory 110 via the memory interface 130 (e.g., a DDR interface) may be defined by the following states: initial and final clock enables CKE_{I}, CKE_{F}, a first and second chip select CS₁, CS₂, row address strobe RAS, column address strobe CAS and write enable WE (although a larger or smaller number of and/or different states may be employed). Because such states are known to a person of skill in the art, the states are not described in detail herein. Therefore, the main processor 114 may issue a command (e.g., bits of data), which targets the first and/or second registers 116, 118 and includes states CKE_{I}, CKE_{F}, CS₁, CS₂, RAS, CAS and WE, on the processor bus 120. The first register control logic 122 may decode the command and write the bits of data to the first and/or second registers 116, 118.

Alternatively or additionally, an external processor 124 may issue a command, which targets the first and/or second registers 116, 118 and includes states CKE_{I}, CKE_{F}, CS₁, CS₂, RAS, CAS and WE, on the external processor interface 126. The second register control logic 128 may decode the command and write the bits of data to the first and/or second registers 116, 118.

The data written to and stored by the first register 116 may include the command to be sent to the memory 110. More specifically, the first register 116 may store one or more encodes associated with the command. Each encode may include values that describe a CKE change (e.g., CKE_{F}-CKE_{I}), CSs (e.g., CS₁ and CS₂), RAS, CAS and WE. Therefore, the first register 116 may serve as a port of the memory 110 through which a command is received.

The command stored by the first register 116 may have an address associated therewith. The address may identify the memory location targeted by the memory command. If the command stored by the first register 116 is associated with an address, the data written to and stored by the second register 118 may include such address. Therefore, the second register 118 may serve as a port of the memory 110 through which the address is received. Alternatively, if the memory command is not associated with an address, the second register 118 may not be employed to perform the non-functional operation on the memory 110.

The following table illustrates exemplary commands associated with a non-functional memory operation and respective binary encodes associated with the commands. The commands are known to a person of skill in the art, and therefore, are not described in detail herein.

| Command | CKE_{I} | CKE_{F} | CS₁ | CS₂ | RAS | CAS | WE |
|---|---|---|---|---|---|---|---|
| Exit Power Down or Self- | 0 | 1 | 1 | 1 | x | x | x |
| Refresh Mode (both Memory Ranks) | | | | | | | |
| Enter Self-Refresh | 1 | 0 | 0 | 0 | 0 | 0 | 1 |
| Mode (both Memory Ranks) | | | | | | | |
| Enter Self-Refresh | 1 | 0 | 0 | 1 | 0 | 0 | 1 |
| Mode (Memory Rank 1) | | | | | | | |
| Enter Self-Refresh | 1 | 0 | 1 | 0 | 0 | 0 | 1 |
| Mode (Memory Rank 0) | | | | | | | |
| Enter Power Down Mode | 1 | 0 | 1 | 1 | x | x | x |
| (both Memory Ranks) | | | | | | | |
| Auto Refresh | 1 | 1 | 0 | 0 | 0 | 0 | 1 |
| (both Memory Ranks) | | | | | | | |
| Pre-charge All Memory Banks | 1 | 1 | 0 | 0 | 0 | 1 | 0 |
| (with address bit 10 = logic “1” | | | | | | | |
| for both Memory Ranks) | | | | | | | |
| Auto Refresh (Memory Rank 1) | 1 | 1 | 0 | 1 | 0 | 0 | 1 |
| Pre-charge All Memory Banks | 1 | 1 | 0 | 1 | 0 | 1 | 0 |
| (with address bit 10 = logic “1” | | | | | | | |
| for Memory Rank 1) | | | | | | | |
| Auto Refresh | 1 | 1 | 1 | 0 | 0 | 0 | 1 |
| (Memory Rank 0) | | | | | | | |
| Pre-charge All Memory Banks | 1 | 1 | 1 | 0 | 0 | 1 | 0 |
| (with address bit 10 = logic “1” | | | | | | | |
| for Memory Rank 0) | | | | | | | |

All others encodes may be reserved; x = don't care

One or more of the command encodes may be written to and stored by the first register 116. As described below, one or more such commands may be sent to the memory 110 to cause the memory to operate in a non-functional mode such as power down and/or initialization. However, any other supported command may also be forced by writing a unique encode into the first register. The address bits (e.g., address bit 10) described in the table refer to an address associated with the command that is stored in the second register 118. Although the table above associates an encode with a command, in some embodiments, the encode may be associated with a different command. Further, the table may include a larger or smaller number of and/or different encodes which may each be associated with a unique command. In this manner, the first and second registers 116, 118 may store bits of data that may cause a non-functional operation to be performed on the memory 110 when such bits are applied thereto.

In step 206, the bits of data may be applied to respective pins 112 of the memory 110 so as to cause the non-functional operation to be performed on the memory 110. For example, assume in step 204, the main processor 114 writes bits of data to the first and/or second registers 116, 118. When the first register control logic 122 decodes such data (e.g., a write transaction which targets the first register 116) on the processor bus 120, the first register control logic 122 may forward such transaction to the memory interface 130. The memory interface 130 may read and decode the contents of the first and/or second registers 116, 118. Further, the memory interface 130 may generate the command which causes the memory 110 to perform a non-functional operation based on the decoded bits, and send such command to the memory 110. More specifically, the memory interface 130 may read and decode the bits of data stored in the first and second registers 116, 118, and apply such decoded bits to corresponding pins 112 of the memory 110. In response, the memory 110 may perform one or more of steps of a sequence included in the non-functional operation. In some embodiments, rather than decode the bits of data stored in the first and/or second registers 116, 118, the memory controller 130 may merely read the bits of data and apply such bits to corresponding pins of the memory 110.

Steps 204 and 206 may be repeated as desired such that a processor 104 of the system 100 causes the memory 110 to perform a customized sequence of steps associated with a non-functional performance. For example, to initiate memory initialization, a processor 104 may cause the encode associated with the command “Enter Self-Refresh Mode (Memory Rank 0)” to be written to the first and/or second register 116, 118. Such encode (or a decoded version thereof) may be applied to corresponding pins 112 of the memory 110 such that Memory Rank 0 operates in a self-refresh mode. Thereafter, to continue the initialization, the processor 104 may cause the encode associated with the command “Enter Self-Refresh Mode (Memory Rank 1)” to be written to the first and/or second register 116, 118. Such encode (or a decoded version thereof) may be applied to corresponding pins 112 of the memory 110 such that Memory Rank 1 operates in a self-refresh mode. To complete initialization, the processor 104 may cause the encode associated with the command “Exit Power Down or Self-Refresh Mode (both Memory Ranks)” to be written to the first and/or second register 116, 118. Such encode (or a decoded version thereof) may be applied to corresponding pins 112 of the memory 110 such that Memory Ranks 0 and 1 exit the self-refresh mode and operate in an automatic refresh mode. The above scenario is exemplary. Therefore, steps of the above-described non-functional memory operation (e.g., memory initialization) may be performed in a different order. Additionally or alternatively, the non-functional memory operation may include a larger or smaller number of and/or different steps. For example, in addition to the steps of the above-described memory initialization, a subsequent initialization of the memory 110 may also pre-charge all Memory Banks associated with an address including a tenth bit which is a logic “1” (for both Memory Ranks).

Thereafter, step 208 may be performed. In step 208, the method 200 ends. Through use of the present method 200, software (e.g., code executed by a processor 104) may be employed to control a non-functional operation (e.g., a memory test or initialization) on the memory 110. For example, the present method 200 enables a processor 104 to control when a non-functional operation is performed on the memory 110 and to customize or program the steps included in the non-functional operation. The register control logic 122, 128 and first and/or second registers 116, 118 may serve as a quick interface through which the non-functional operation may be performed on the memory 110. Further, because a processor 104 may directly write control bits to the memory 110 (e.g., via register control logic 122, 128 and the first and/or second registers 116, 118), the system 110 may include a reduced amount of logic. For example, the system 110 may not require command truth table and/or sequencer logic to perform a memory test and/or calibration.

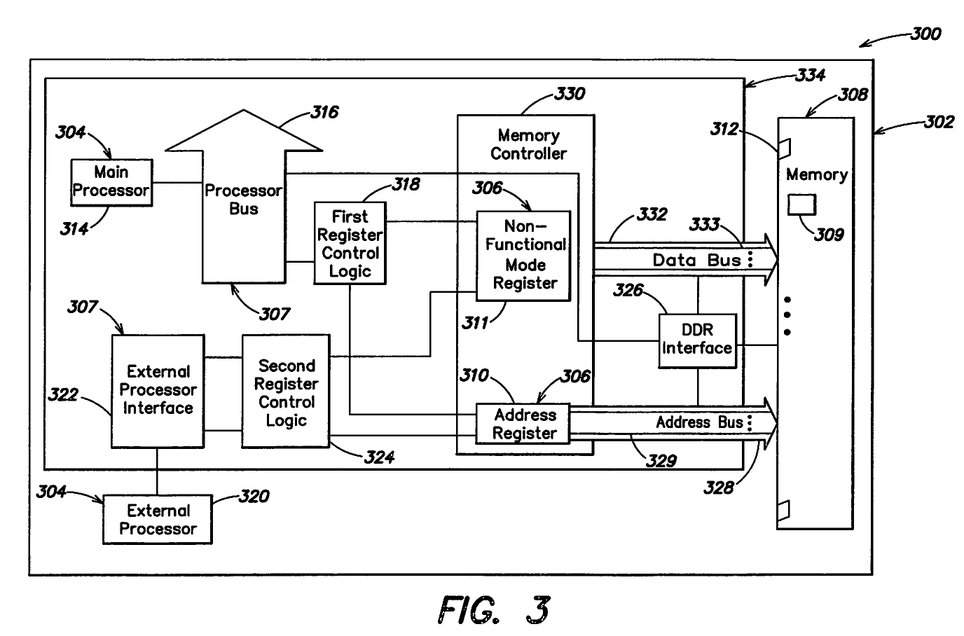

In the first exemplary system 100, all the bits of data employed to cause the memory 110 to perform a non-functional task are passed through the one or more registers 116, 118. However, in other embodiments, some of the bits of data employed to cause the memory 110 to perform a non-functional task are passed through the one or more registers 116, 118 and some other bits of the data employed to cause the memory 110 to perform the non-functional task are transmitted to the memory 110 through a different path. FIG. 3 is a block diagram of a second exemplary system 300 for controlling a non-functional operation on a memory of the system 300 using software in accordance with an embodiment of the present invention. With reference to FIG. 3, the system 300 may be a computer 302 or similar device. The system 300 may include one or more processors 304 coupled to one or more registers 306 via respective interfaces 307. The one or more registers 306 may be coupled to a memory 308 (e.g., DRAM) of the system 300. The memory 308 may perform functional operations, such as allowing data to be read therefrom and/or written thereto. Further, the memory 308 may perform non-functional operations, such as adjustment (e.g., calibration) of impedance of an off-chip driver (e.g., the memory 308). Memory impedance may be adjusted during initialization of the memory chip. An off-chip driver impedance adjustment sequence may be employed to adjust the memory impedance. The sequence includes a series of writes to the Extended Mode Register Set (2) (EMRS(2)) 309 of the memory 308. One of those writes may be the memory impedance adjustment command. Such command requires that data be driven to all of the dual inline memory modules (DIMMs) of the memory 308 to control the impedance adjustment. Details of such memory impedance adjustment are described below.

Each processor 304 may be adapted to execute code which causes data to be read from and/or written to the register 306. For example, the one or more registers 306 may include an address register 310 and a non-functional mode register 311. Each processor 304 may be adapted to write data to the address register 310. The address register 310 will store the data written thereto by the processors 304. Further, each processor 304 may be adapted to write one or more bits to the non-functional mode register 311 to indicate whether the system 300 operates in a non-functional mode, such as a mode in which the impedance of the memory 308 is adjusted. When the system 300 operates in the non-functional mode (e.g., impedance adjustment mode), the data written to the address register 310 may serve as a first portion of control bits that may cause the memory 308 to perform a non-functional operation when applied thereto. For example, the data written to the address register 310 may include a first set of bits that cause the memory 308 to perform one or more steps of a first sequence associated with a non-functional operation such as memory initialization. For example, the first sequence may include a first step in which all banks of the memory 308 are pre-charged and a second step in which the memory 308 enters a power down mode. Remaining control bits that cause the memory 308 to perform the non-functional operation may be included in a functional memory command (e.g., a write command) from the processor 304. Rather than flow through the address register 310, the remaining control bits may be applied to the memory 308 via a different path (e.g., that employed by a functional memory operation). Such data path is described below.

Thereafter, the processor 304 may write a second set of bits that cause the memory to perform one or more steps of a second sequence associated with memory initialization. The second sequence of steps may include the same steps as the first sequence but in a different order. For example, the second sequence may include a first step in which the memory 308 enters the power down mode and a second step in which all banks of the memory 308 are pre-charged. Alternatively, the second sequence may include a larger or smaller number of steps and/or different steps than the first sequence. Thus, the system 300 may customize a non-functional operation by varying the control bits.

In the present system, a processor 304 may directly write memory control signals to the registers 306 which may be applied to respective pins 312 of the memory 308 and cause the memory 308 to perform a non-functional operation. Consequently, the present system 300 may not require additional hardware, such as sequencer logic, to perform a memory impedance adjustment. Therefore, a space required by the present system 300 may be reduced (compared to that required by conventional systems).

More specifically, the system 100 may include a first processor 314, such as a main processor, coupled to the address register 310 via a processor bus 316. First register control logic 318 may be coupled to the processor bus 316 and adapted to decode commands on the processor bus 316 and read data from and/or write data to the address register 310.

The system 300 may include a second processor 320 which may be external to the main processor 314, coupled to the address register 310 via an external processor interface 322. In some embodiments, the external processor interface 322 may be a serial peripheral interface (SPI), an Inter-IC (I²C) interface or another suitable interface adapted to enable the external processor 320 to access the address register 310. Second register control logic 324 may be coupled to the external processor interface 322 and adapted to decode a command on the interface 322 and read data from and/or write data to the address register 310. Although first register control logic 318 is shown separate from the second register control logic 324, in some embodiments, the first and second register control logic 318, 324 may be integrated and coupled to both the processor bus 316 and external processor interface 322.

The address and non-functional mode register 310, 311 may be external to the one or more processors 304 (e.g., may be MMIO registers). Further, address register and/or non-functional mode register 310, 311 may be coupled to the memory 308 via a memory interface 326, such as a dual data rate (DDR) interface or other suitable interface. For example, the address register 310 may be coupled to the memory interface 326 via an address bus 328. The address bus 328 may include a plurality of bus lines 329. The address bus 328 may be adapted transmit data stored by the address register 310 to the memory interface 326. As described above, the data stored by the address register 326 may serve as a portion of control bits that cause the memory 308 to perform a non-functional operation.

In some embodiments, the address register 310 may be included in a memory controller 330 of the system 300 (although the address register 310 may be positioned elsewhere). The memory controller 330 may be coupled to the memory interface 326 and adapted to control the flow of data to and from the memory 308. The memory interface 326 may serve as an interface between the memory controller 330 and the memory 308. The memory interface 326 may receive data associated with a functional operation, such as a memory read or write, from a processor 304 via the memory controller 330. For example, the system 300 may include a data bus 332 coupling the memory controller 330 to the memory 308. The data bus 332 may include a plurality of bus lines (e.g., 64 bus lines) 333. The memory interface 326 may be coupled to the data bus 332. Further, the memory interface 326 may receive the data associated with the functional operation and apply such data to corresponding pins 312 of the memory 308.

Additionally or alternatively, the memory interface 326 may receive data associated with a non-functional operation and apply such data to corresponding pins 312 of the memory 308. For example, when the system operates in the non-functional mode (e.g., as indicated by data stored in the non-functional mode register 311), the memory interface 326 may receive the data stored by the address register 310 and apply such data to corresponding pins 312 of the memory 308 so as to cause the memory 308 to perform the non-functional operation. Further, when the system 300 operates in the non-functional mode, the memory interface 326 may receive a “functional” operation from a processor 304. Portions of the data associated with the functional operation may serve as the remaining control bits that cause the memory 308 to perform the non-functional operation. Therefore, such functional operation actually serves as a control operation that causes the memory 308 to perform the non-functional operation. The memory interface 326 may apply such control bits to corresponding pins 312 of the memory 308 so as to cause the memory 308 to perform the non-functional operation.

In some embodiments, the main processor 314 and memory controller 330 may be included on a single printed circuit board (PCB) 334, and the processor 320 may be external to such PCB 334. However, in some embodiments, the main processor 314 and memory controller 330 may be on separate PCBs 334.

Operation of the system 300 is now described with reference to FIG. 2 which illustrates a method 200 of controlling a non-functional operation on a memory 308 of the system 300 using software in accordance with an embodiment of the present invention. With reference to FIG. 2, in step 202, the method 200 begins. In step 204, a processor 304 may be employed to write bits of data to at least one register 306 external to the processor 304. The bits of data may serve as a portion of control bits for the memory 308 that indicate one or more steps of a sequence associated with the non-functional operation that is to be performed on the memory 308.

For example, the processor 304 may write one or more bits to the non-functional mode register 311 to indicate that the system 300 is operating in a non-functional mode (e.g., an impedance adjustment mode). More specifically, the main processor 314 may write the non-functional mode register 311 via the processor bus 316 or an external processor 320 may write the non-functional mode register 311 via the external processor interface 322. Additionally, the processor 304 may write bits of data to the address register 310. Such bits may serve as a portion of control bits (e.g., bits A15-A10 and A6-A0 described below) that may initiate one or more steps of a first sequence associated with memory impedance adjustment when the control bits are applied to corresponding pins 312 of the memory 308. Further, the main processor 314 may issue data associated with a functional command (e.g., bits of data), such as a memory write command, on the processor bus 316. However, because the system 300 is operating in the non-functional mode, portions of the data of the functional command may actually serve as the remaining control bits (e.g., bits A9-A7 and DT0-DT3) described below) that may initiate one or more steps of the first sequence associated with memory impedance adjustment. In some embodiments, only bits A9-A7 and DT0-DT3 may change during the memory impedance adjustment. To wit, bits A15-A10 and A6-A0 may remain unchanged throughout the memory impedance adjustment. Therefore, the processor functional command may control the memory 308 behavior during impedance adjustment. Therefore, bits of the address associated with the functional command that serve as bits A7-A9 may be assigned values such that the memory 308 performs a desired function during impedance adjustment. Further, for the non-functional memory command, the data bits of the functional command should be assigned values such that the system 300 may make a desired impedance adjustment on the memory 308.

For example, the main processor 314 may issue a first command and an address associated therewith on the processor bus 316. The first register control logic 318 may decode such data on the processor bus 316, and read data from or write data to the address register 310 based on the decoding. In this manner, the first register control logic 318 may translate a command to a register write by decoding an address range associated with the command and write the first portion of the control bits to the address register 310. Further, the main processor 314 may issue a second “functional” command (e.g., bits of data) on the processor bus 316. Such “functional” command may be received by the memory interface 326 via the memory controller 330.

Alternatively or additionally, an external processor 320 may write bits of data to the address register 310. Such bits may serve as a portion of control bits (e.g., bits A15-A10 and A6-A0 described below) that may initiate one or more steps of the first sequence associated with memory impedance adjustment when such bits are applied to corresponding pins 312 of the memory 308. For example, the external processor 320 may issue a command and an address associated therewith on the external processor interface 322. The second register control logic 324 may decode such data on the external processor interface 322, and read data from or write data to the address register 310 based on the decoding. Such bits of data may not change during the memory impedance adjustment sequence. In this manner, the second register control logic 324 may translate a command to a register write by decoding an address range associated with the command. Although memory impedance adjustment is described above, any other memory command (e.g., non-functional command) supported by the memory interface 326 may be generated by employing a processor 304 to perform the above-described register write operation. Consequently, the present invention may force a command to memory through a register write operation. Further, the main processor 314 may issue a second “functional” command (e.g., bits of data) on the processor bus 316, which may be received by the memory interface 326 via the memory controller 330.

By adjusting one or more of the control bits, the processor 304 may control the type of non-functional operation (and sequence of steps included therein) performed on the memory 308. Therefore, by employing the processor 304 to (1) directly write data (e.g., via the first register control logic 318 and processor bus 316 or the second register control logic 324 and external processor interface 322) to the address register 310; and (2) to issue a functional command when the system operates in the non-functional mode, the system 300 provides a flexible method of performing a non-functional operation on the memory 308.

In some embodiments, a command to perform a memory operation may include sixteen address bits A15-A0 and at least four data bits DT0, DT1, DT2, DT3. However, the command may include a larger or smaller number of address and/or data bits. Further, in some embodiments, the command may include different types of bits. When the system 300 operates in the non-functional mode, data stored by and read from the address register 310 may serve as bits A15-A10 and A6-A0 of the control command. Further, portions of the “functional” command issued by the processor 304 when the system 300 operates in the non-functional mode may serve as bits A9-A7 and DT0-DT3 of the control command. However, data stored by the address register 310 may serve as a larger or smaller and/or different portion of the control command. Additionally or alternatively, portions of the functional command issued by the processor 304 when the system 300 operates in the non-functional mode may serve as a larger or smaller and/or different portion of the control command.

Therefore, when operating in the non-functional mode, the main processor 314 may issue a command (e.g., bits of data), which targets the address register 310 and includes data that will serve as control bits A15-A10 and A6-A0 on the processor bus 316. The first register control logic 318 may decode the command and write the bits of data to the address register 310. Further, the main processor 314 may issue a command to perform a functional memory operation, such as a memory write. Such command includes bits of data that will serve as control bits A9-A7 and DT0-DT3.

Alternatively or additionally, an external processor 320 may issue a command, which targets the address register 310 and includes data that will serve as control bits A15-A10 and A6-A0 on the external processor interface 322. The second register control logic 324 may decode the command and write the bits of data to the address register 310. Therefore, the address register 310 may serve as a port of the memory 308 through which some bits of a control command are received. Further, the main processor 314 may issue a command to perform a functional memory operation, such as a memory write. Such command includes bits of data that will serve as control bits A9-A7 and DT0-DT3.

In step 206, the bits of data may be applied to respective pins 312 of the memory 308 so as to cause the non-functional operation to be performed on the memory 308. For example, assume in step 204, the main processor 314 writes bits of data to the address register 310. When the first register control logic 318 decodes such data (e.g., a write transaction which targets the address register 310) on the processor bus 316, the first register control logic 318 may forward such transaction to the memory interface 326. Therefore, the memory interface 326 receives data that will serve as control bits A15-A10 and A6-A0. Further, the memory interface 326 may receive the “functional” command issued by the processor 314. The “functional” command may employ the same path to the memory 308 as a normal write operation. Such command includes data that will serve as control bits A9-A7 and DT0-DT3. The memory interface 326 may read and decode the contents of the address register 310 and the “functional” command and generate the non-functional command which causes the memory to perform a non-functional operation based on the decoding, and send such command to the memory 308. For example, to form the non-functional command, the memory interface 326 may receive a column command of the “functional” command and replace the column address bits thereof with address register bits 15:10 concatenated with bits 9:7 of the column address concatenated with address register bits 6:0. Column address bits 9:7 may represent the off-chip driver (e.g., memory) calibration command encode. More specifically, the non-functional command may include bits A15-A0 and DT0-DT3. The memory interface 326 may apply such bits to corresponding pins 312 of the memory 308. In response, the memory 308 may perform one or more of steps of a sequence included in the non-functional operation.

The following table illustrates exemplary sub-operations associated with a non-functional memory operation and respective binary encodes associated with the sub-operation.

| Sub-Operation | A9 | A8 | A7 |
|---|---|---|---|
| Off-Chip Driver Calibration | 0 | 0 | 0 |
| Mode Exit | | | |
| Drive(1) DQ, DQS, RDQS high | 0 | 0 | 1 |
| and DQS low | | | |
| Drive(0), DQ, DQS, RDQS low | 0 | 1 | 0 |
| and DQS high | | | |
| Adjust Mode | 1 | 0 | 0 |
| Off-Chip Calibration Default | 1 | 1 | 1 |

Control bits A15-A10 and A6-A0 may be of a low logic state. However, one or more of control bits A15-A10 and A6-A0 may have a different logic state. The system 300 may employ one or more of the above sub-operations to adjust and/or calibrate the impedance of the memory 308. More specifically, the system 300 may employ one or more of the above sub-operations such that the impedance on each pin 312 of the memory 308 matches that on the opposite side of a bus line 333 coupled thereto. For example, during impedance adjustment a value of “111” for bits A9-A7 may be employed to set all values (e.g., impedances on the memory pins 312) to a default value. A value of “001” may be employed to drive first values on the data bus 332 (e.g. a line 333 thereof) during memory impedance adjustment. More specifically, data signal DQ, and redundant data strobe (RDQS), and data strobe (DQS) are high. Alternatively, a value of “010” for bits A9-A7 may be employed to drive second values on the data bus 332 (e.g., on a line 333 thereof) during memory impedance adjustment. More specifically, signal DQ and RDQS are low, and signal DQS is high. However, different values may be employed for the first and/or second values. Data bus signals, such as DQ, DQS and RDQS, are known to one of skill, and therefore, are not described in detail herein.

When the first or second data values are driven on a line 333 of the data bus 332, values may be reflected back to the pin 312. If the reflected values do not match the values driven on the line 333, the system 300 may employ the Adjust Mode sub-operation to adjust memory impedance until values reflected back to a pin 312 match the values initially driven on a bus line 333 coupled to the pin 312. More specifically, a value of “100” may be employed for bits A9-A7. In the Adjust Mode sub-operation, bits DT0-DT3 may indicate a step employed to adjust memory impedance. Bits DT0-DT3 may be applied as a 4-bit burst to all DQ pins 312 of the memory 308. The following table defines steps included in the sub-operation “Adjust Mode” (e.g., when bits A9-A7 are “100” respectively) such that memory impedance may be adjusted.

Steps of Adjust Mode

| 4-bit burst code input to | | | | Pull-up | Pull-down |
|---|---|---|---|---|---|
| all DQs | | | | driver | driver |
| DT0 | DT1 | DT2 | DT3 | strength | strength |
| 0 | 0 | 0 | 0 | No | NOP |
| | | | | operation | |
| | | | | (NOP) | |
| 0 | 0 | 0 | 1 | Increase by | NOP |
| | | | | 1 step | |
| 0 | 0 | 1 | 0 | Decrease by | NOP |
| | | | | 1 step | |
| 0 | 1 | 0 | 0 | NOP | Increase by |
| | | | | | 1 step |
| 1 | 0 | 0 | 0 | NOP | Decrease by |
| | | | | | 1 step |
| 0 | 1 | 0 | 1 | Increase by | Increase by |
| | | | | 1 step | 1 step |
| 0 | 1 | 1 | 0 | Decrease by | Increase by |
| | | | | 1 step | 1 step |
| 1 | 0 | 0 | 1 | Increase by | Decrease by |
| | | | | 1 step | 1 step |
| 1 | 0 | 1 | 0 | Decrease by | Decrease by |
| | | | | 1 step | 1 step |

| | | |
|---|---|---|
| All other combinations of | Reserved | Reserved |
| DT0–DT3 | | |

Pull-up driver strength may refer to a first resistance provided by a first resistive element (e.g., in the memory 308). Similarly, Pull-down driver strength may refer to a second resistance provided by a second resistive element (e.g., in the memory 308). To adjust the impedance on a pin 312 of the memory 308, the first resistance and/or second resistance may be increased or decreased by one step or unit (e.g., a predetermined number of ohms). For example, when bits A9-A7 are “100” and bits DT0-DT3 are “0110”, the first resistance may be decreased by one step and the second resistance may be increased by one step. Thereafter, a value of “001” or “010” for bits A9-A7 may be employed to drive the first or second data values, respectively, on a line 333 of the data bus 332. If a value reflected back to the pin 332 matches that initially driven on the bus line 333 coupled to the pin 312 the impedance adjustment of that pin 312 is complete. Alternatively, if the value reflected back to the pin 332 still does not match that initially driven on the bus line 333 coupled to the pin 312, one or more of the adjustment mode steps may be employed to adjust resistance provided by the first and/or second resistive element. Such process may be repeated until the impedance is matched on the pin 312. The above process may be performed for each pin 312 of the memory 308. Once impedance is matched for all pins 312 of the memory 308, the impedance adjustment for the memory 308 is complete. A value “000” for bits A9-A7 may be employed to indicate that driver impedance adjustment is complete. The tables above are exemplary. Therefore, a different encode may be employed for one or more of the above steps or sub-operations. Further, a larger or smaller number of and/or different steps or sub-operations may be employed.

Thereafter, step 208 may be performed. In step 208, the method 200 ends. Through use of the present method 200, software (e.g., code executed by a processor 314) may be employed to control a non-functional operation (e.g., memory impedance adjustment) on the memory 308. For example, the present method 200 enables a processor 304 to control when a non-functional operation is performed on the memory 308 and to customize or program the steps included in the non-functional operation. More specifically, the present invention adds at least one register 310 that provides address/control bits for all writes to the EMRS(2) registers in the memory 308. This register 310 is used to provide the bits that do not change in a sequence of EMRS(2) writes that are performed in the impedance adjustment sequence. In addition, a register 311 for storing at least one mode bit is added. When the at least one mode bit is active, the system 300 may force writes to address register 310 and a “functional” command issued in the non-functional mode to be converted by the memory interface 326 to writes to the EMRS(2) registers 309 which causes the memory 308 to perform the non-functional operation. The “functional” command (e.g., a normal write command) may provide control bits that change during the memory impedance calibration sequence as well as the data required for each of the memory 308 (e.g., each DIMM included therein) when executing the Impedance Adjust command. Further, because a processor 304 may directly write control bits to the memory 308 (e.g., via register control logic 318, 324 and the address register 310), the system 300 may include a reduced amount of logic. For example, the system 300 may not require command truth table and/or sequencer logic to perform memory test and/or calibration.

The foregoing description discloses only exemplary embodiments of the invention. Modifications of the above disclosed apparatus and methods which fall within the scope of the invention will be readily apparent to those of ordinary skill in the art. For instance, in some embodiments, the memory interface 326 may be an extreme data rate (XDR) interface, and the memory 308 may be a double data rate 2 (DDR2) DRAM. However, the system 100, 300 may include a different type of interface and/or memory. By employing the “functional” command to provide control bits for the memory impedance adjustment, the present invention may reduce an amount of hardware employed thereby.

Accordingly, while the present invention has been disclosed in connection with exemplary embodiments thereof, it should be understood that other embodiments may fall within the spirit and scope of the invention, as defined by the following claims.

The invention claimed is:

1. A method of controlling a non-functional operation on a memory of a computer system using software, comprising:
employing a processor to write bits of data to at least one register external to the processor, wherein the bits of data serve as control bits for the memory; and
applying the bits of data to respective pins of the memory so as to cause the non-functional operation to be performed on the memory.

2. The method of claim 1 wherein employing the processor to write bits of data to the register external to the processor includes employing a main processor of the computer system to write data, via a processor bus, to the register.

3. The method of claim 1 wherein employing the processor to write bits of data to the register external to the processor includes employing a processor external to a main processor of the computer system to write the data, via an external processor interface, to the register.

4. The method of claim 1 wherein the non-functional operation includes at least one of a memory test and memory initialization.

5. The method of claim 1 wherein the non-functional operation includes driver impedance adjustment.

6. The method of claim 1 further comprising applying additional bits of data to remaining pins of the memory so as to cause the non-functional operation to be performed on the memory, wherein the additional bits of data are associated with a functional memory command issued by a main processor of the computer system.

7. The method of claim 1 wherein applying the bits of data to respective pins of the memory so as to cause the non-functional operation to be performed on the memory includes applying the bits of data to respective pins of the memory so as to cause one or more steps of a first sequence associated with the non-functional operation to be performed on the memory.

8. The method of claim 7 further comprising:
employing the processor to write additional bits of data to the at least one register external to the processor, wherein the additional bits of data serve as control bits for the memory; and
applying the additional bits of data to respective pins of the memory so as to cause one or more steps of a second sequence associated with the non-functional operation to be performed on the memory.

9. An apparatus for controlling a non-functional operation on a memory of a computer system using software, comprising:
one or more processors; and
one or more registers external to the processors and coupled thereto and further adapted to couple to the memory;
wherein the apparatus is adapted to:
employ one of the processors to write bits of data to at least one of the registers, wherein the bits of data serve as control bits for the memory; and
apply the bits of data to respective pins of the memory so as to cause the non-functional operation to be performed on the memory.

10. The apparatus of claim 9 wherein the one or more processors includes a main processor; and
further comprising a processor bus coupling the main processor to the one or more registers;
wherein the apparatus is further adapted to employ the main processor of the computer system to write the data, via the processor bus, to at least one of the registers.

11. The apparatus of claim 9 wherein the one or more processors includes a main processor and a processor external to the main processor; and
further comprising an external processor interface coupling the external processor to the one or more registers;
wherein the apparatus is further adapted to employ the external processor of the computer system to write the data, via the external processor interface, to at least one of the registers.

12. The apparatus of claim 9 wherein the non-functional operation includes at least one of a memory test and memory initialization.

13. The apparatus of claim 9 wherein the non-functional operation includes driver impedance adjustment.

14. The apparatus of claim 9 wherein:
the one or more processors includes a main processor;
the apparatus is further adapted to apply additional bits of data to remaining pins of the memory so as to cause the non-functional operation to be performed on the memory; and
the additional bits of data are associated with a functional memory command issued by the main processor of the computer system.

15. The apparatus of claim 9 wherein the apparatus is further adapted to apply the bits of data to respective pins of the memory so as to cause one or more steps of a first sequence associated with the non-functional operation to be performed on the memory.

16. The apparatus of claim 15 wherein the apparatus is further adapted to:
employ the processor to write additional bits of data to the at least one register external to the processor, the additional bits of data serve as control bits for the memory; and
apply the additional bits of data to respective pins of the memory so as to cause one or more steps of a second sequence associated with the non-functional operation to be performed on the memory.

17. A system for controlling a non-functional operation on a memory of the system using software, comprising:
one or more processors;
one or more registers, external to the processors and coupled thereto; and
a memory coupled to the one or more registers;
wherein the system is adapted to:
employ one of the processors to write bits of data to at least one of the registers, wherein the bits of data serve as control bits for the memory; and
apply the bits of data to respective pins of the memory so as to cause the non-functional operation to be performed on the memory.

18. The system of claim 17 wherein the one or more processors includes a main processor; and
further comprising a processor bus coupling the main processor to the one or more registers;
wherein the system is further adapted to employ the main processor of the computer system to write the data, via the processor bus, to at least one of the registers.

19. The system of claim 17 wherein the one or more processors includes a main processor and a processor external to the main processor; and
further comprising an external processor interface coupling the external processor to the one or more registers;
wherein the system is further adapted to employ the external processor of the computer system to write the data, via the external processor interface, to at least one of the registers.

20. The system of claim 17 wherein the non-functional operation includes at least one of a memory test and memory initialization.

21. The system of claim 17 wherein the non-functional operation includes driver impedance adjustment.

22. The system of claim 17 wherein:
the one or more processors includes a main processor;
the system is further adapted to apply additional bits of data to remaining pins of the memory so as to cause the non-functional operation to be performed on the memory; and
the additional bits of data are associated with a functional memory command issued by the main processor of the computer system.

23. The system of claim 17 wherein the system is further adapted to apply the bits of data to respective pins of the memory so as to cause one or more steps of a first sequence associated with the non-functional operation to be performed on the memory.

24. The system of claim 23 wherein the system is further adapted to:
employ the processor to write additional bits of data to the at least one register external to the processor, the additional bits of data serve as control bits for the memory; and
apply the additional bits of data to respective pins of the memory so as to cause one or more steps of a second sequence associated with the non-functional operation to be performed on the memory.
